(19) United States
(12) Patent Application Publication
(10) Pub. No.: US 2012/0018545 A1
(43) Pub. Date: Jan. 26, 2012

(54) MODULAR COMPRESSOR PACKAGE FOR HVLP SPRAYER

(76) Inventors: Diane L. Olson, Princeton, MN (US); Mark D. Shultz, Minneapolis, MN (US); Craig J. Wojciechowski, Foley, MN (US)

(21) Appl. No.: 13/142,811

(22) PCT Filed: Dec. 28, 2009
(86) PCT No.: PCT/US09/69608

§ 371 Date: Jun. 29, 2011

Related U.S. Application Data
(60) Provisional application No. 61/141,281, filed on Dec. 30, 2008.

(51) Int. Cl. B05B 15/00

(52) U.S. Cl. 239/590

(57) ABSTRACT

The invention, generally (10), has an injection molded box (12), in which is mounted a small air compressor (14). The modular assembly (16) can be installed in place of the intake filters (18) on an HVLP spray system (20), with the filter componentry (18) being relocated to the air intake side (22) of the compressor package (16).

### TECHNICAL FIELD

This application claims the benefit of U.S. application Ser. No. 61/141,281,filed Dec. 30, 2008, the contents of which are hereby incorporated by reference.

### BACKGROUND ART

Currently, HVLP sprayer users have two options available to achieve the enhanced system performance provided from a portable pressurized remote cup vs. the standard gun-mounted siphon cup; one option is a fully integrated HVLP system with an internal compressor, as is found with the older Graco® ProComp™ product. This requires a costly upfront investment by the end-user, and if not initially purchased cannot be upgraded to later. Alternatively, a freestanding compressor unit that works in conjunction with a free-standing HVLP unit, requiring a separate AC power source for operation can be utilized. This option requires a separate power source, and is a less portable option, requiring the user to transport and store two pieces of equipment.

### DISCLOSURE OF THE INVENTION

It is an object of this invention to provide a modular compressor package that simply installs onto an HVLP spray system, giving the user the immediate enhanced system performance provided from a portable (less than 2 gallon) pressurized remote cup vs. the standard gun-mounted siphon cup.

The invention is comprised of an injection molded box, in which is mounted a small air compressor (FIG. 1). The modular assembly can be installed in place of the intake filters on an HVLP spray system, with the filter componentry being relocated to the air intake side of the compressor package (FIG. 3).

All electrical connections are achieved by means of a 3-prong quick disconnect that is immediately mated as the compressor package is pushed into place, requiring no wiring or separate connection by the user. The simplicity of installation is further achieved by installation guide features on both the molded compressor box and the HVLP sprayer, which mate in proper orientation thereby prohibiting incorrect installation. (FIG. 1 & FIG. 2)

Once installed, the portable pressurized remote cup is attached by means of the air outlet quick-disconnect fitting of the compressor package (FIG. 1).

The described invention allows the user to upgrade their equipment to achieve the performance enhancements described after their original purchase, achieve the portability of a fully integrated unit, utilize only one power source, and have the flexibility to remove the compressor package at any time.

These and other objects and advantages of the invention will appear more fully from the following description made in conjunction with the accompanying drawings wherein like reference characters refer to the same or similar parts throughout the several views.

### BRIEF DESCRIPTION OF DRAWINGS

FIG. 1 shows the compressor module of the instant invention.

FIG. 2 shows a sprayer with the filter removed.

FIG. 3a shows the sprayer with the standard filter in place.

FIG. 3b shows the filter being removed.

FIG. 3c shows the compressor module along with relocation of the filters.

FIG. 3d shows the sprayer with the compressor module in place.

### BEST MODE FOR CARRYING OUT THE INVENTION

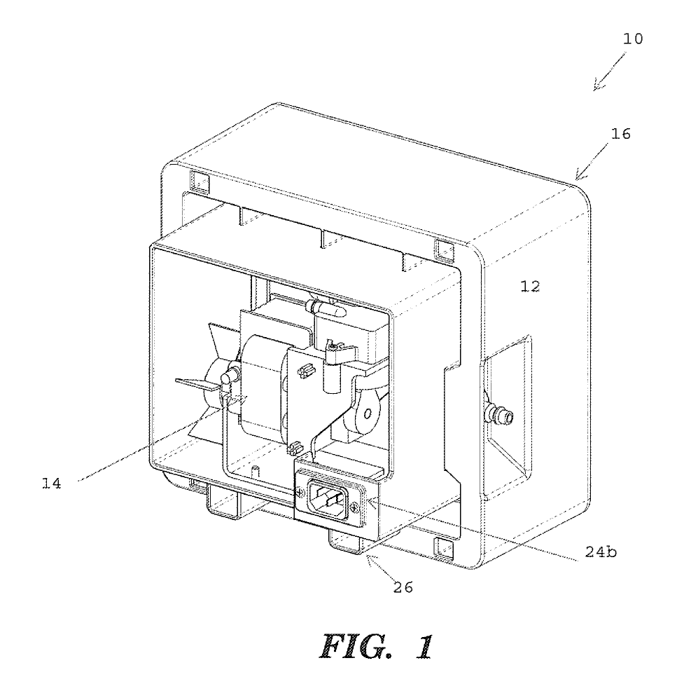

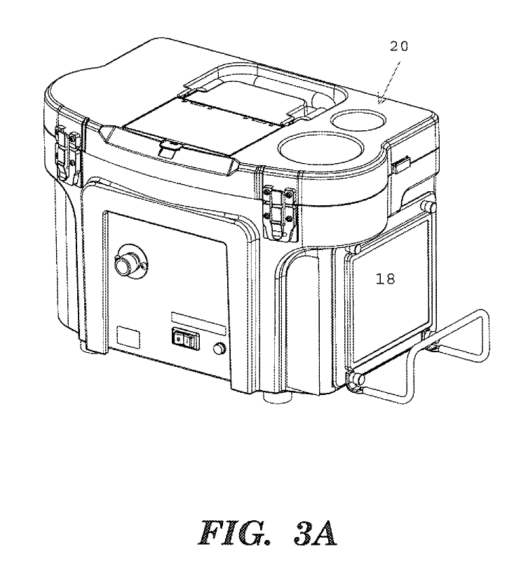

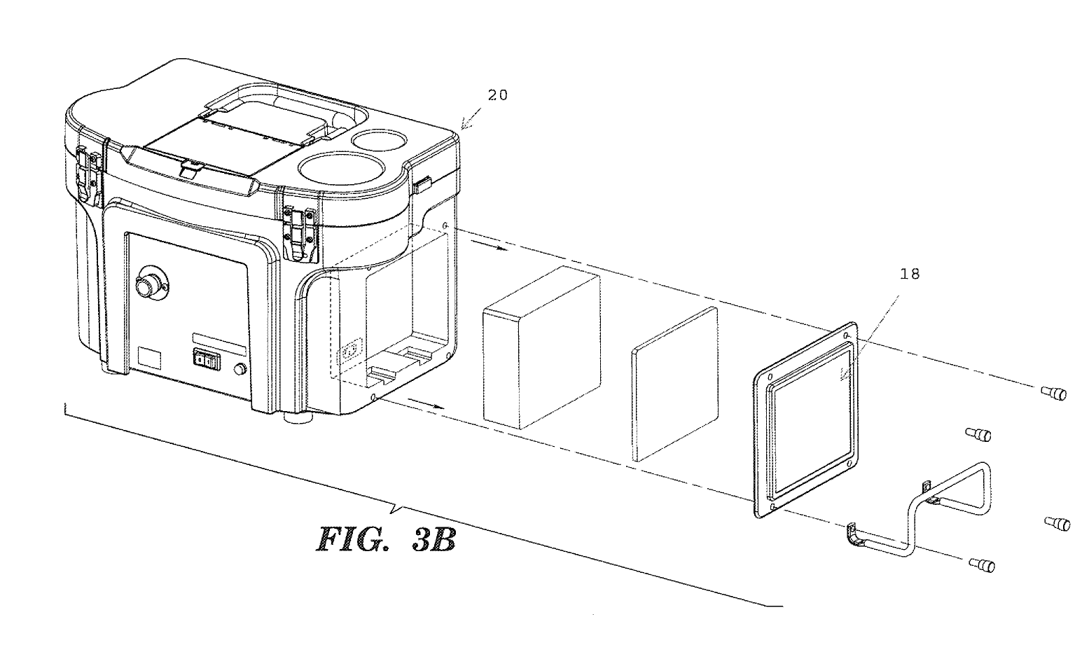

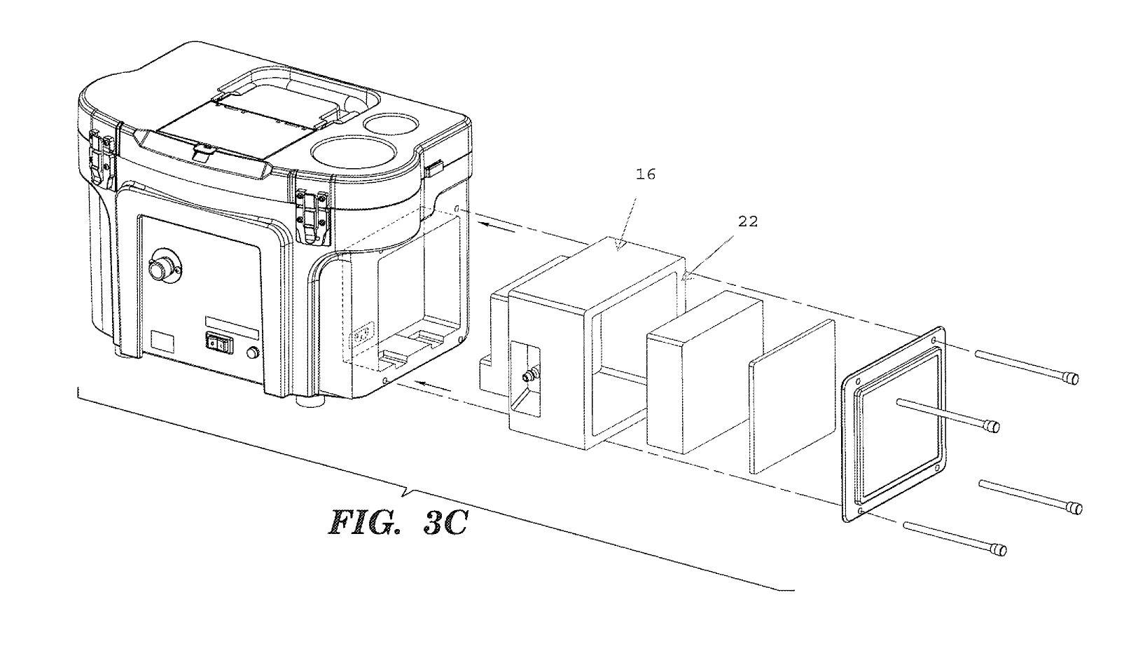

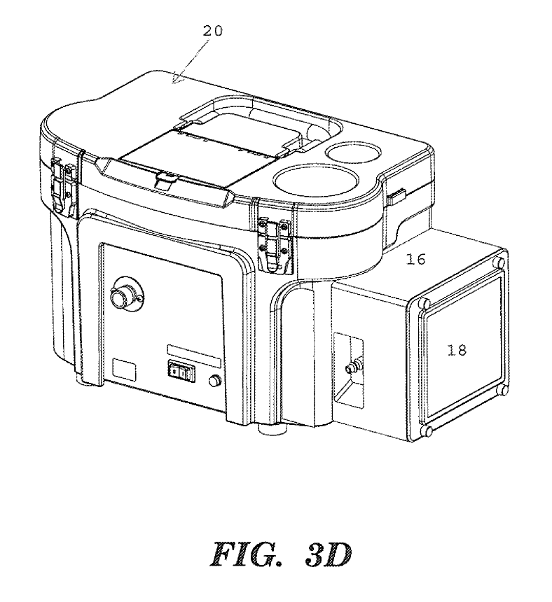

The invention, generally 10, is comprised of an injection molded box 12, in which is mounted a small air compressor 14 (FIG. 1). The modular assembly 16 can be installed in place of the intake filters 18 on an HVLP spray system 20 having a housing 21, with the filter componentry 18 being relocated to the air intake side 22 of the compressor package 16 (FIG. 3).

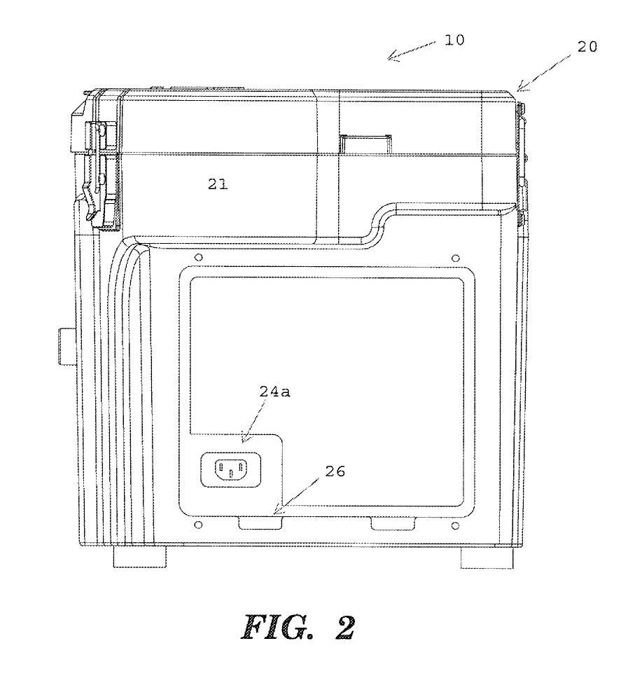

All electrical connections are achieved by means of a 3-prong connector (24a and 24b) that is immediately mated as the compressor package 16 is pushed into place, requiring no wiring or separate connection by the user. The simplicity of installation is further achieved by installation guide features 26 on both the molded compressor box 12 and the HVLP sprayer 20, which mate in proper orientation thereby prohibiting incorrect installation. (FIG. 1 & FIG. 2)

It is contemplated that various changes and modifications may be made to the sprayer without departing from the spirit and scope of the invention as defined by the following claims.

1. A paint sprayer for use with an optional air compressor module and comprising:
a housing;
an air filter removable retained in said housing; and
a quick-disconnect source of power located in said housing behind said filter.

2. The paint sprayer of claim 1 further comprising an air compressor module mountable in place of said filter and comprising an air compressor and a quick-disconnect power connector.

3. The paint sprayer of claim I further comprising mating guides in said housing and on said module to help mate said housing and module during connection.
